(19) United States
(12) Patent Application Publication
(10) Pub. No.: US 2016/0042830 A1
(43) Pub. Date: Feb. 11, 2016

(54) ELECTRICAL INSULATING OIL COMPOSITION

(71) Applicant: IDEMITSU KOSAN CO., LTD., Tokyo (JP)

(72) Inventor: Takashi OHNO, Kitakyushu-shi (JP)

(73) Assignee: IDEMITSU KOSAN CO., LTD., Chiyoda-ku, Tokyo (JP)

(21) Appl. No.: 14/778,947

(22) PCT Filed: Mar. 25, 2014
(86) PCT No.: PCT/JP2014/058315

§ 371 Date: Sep. 21, 2015

(30) Foreign Application Priority Data
Mar. 25, 2013 (JP) 2013-063068

(51) Int. Cl. H01B 3/22

(52) U.S. Cl. CPC H01B 3/22

(57) ABSTRACT

Provided is an electrical insulating oil composition containing, as base oils, (A) one or more selected from hydrorefined mineral oils and synthetic hydrocarbon oils, and (B) a naphthenic solvent-refined mineral oil that has a ratio of carbon atoms in the naphthene content (% C_{N}) of 50% or more and 70% or less in ring analysis according to an n-d-M method, an acid value of 0.03 mg KOH/g or less and a sulfur content of 0.1% by mass or less. The electrical insulating oil composition contains the component (B) in an amount of 50% by mass or more and 70% by mass or less based on the total amount of the base oils, and has a flash point of 135° C. or higher as measured according to a closed cup flash point test method, a pour point of −40° C. or lower, and a density of 0.895 g/cm³ or less. The oil composition is more excellent in point of both electrical insulation characteristics and oxidation stability than before.

### TECHNICAL FIELD

The present invention relates to an electrical insulating oil composition, and relates to an electrical insulating oil composition which is, while maintaining electrical insulation characteristics, excellent also in oxidation stability.

### BACKGROUND ART

Electrical insulating oil is used in various insulated instruments such as oil-immersed transformers, cables, capacitors, etc. Electrical insulating oil is kept used for a long period of time of 10 years or more. In particular, in a case of a large-sized transformer, occurrence of trouble would cause a massive power failure and the social impact thereof would be immeasurable. Consequently, thorough maintenance management of electrical insulating oil is carried out. For maintenance management of electrical insulating oil, one effective method includes checking for degradation of electrical insulating oil based on the outward appearance of the electrical insulating oil, especially the hue thereof. In general, the hue of electrical insulating oil becomes brown when degradation proceeds. Accordingly, in an unused state or in an initial stage of use thereof, electrical insulating oil is required to be nearly colorless and transparent, in order that the degree of degradation of the oil could be readily checked for.

Given the situation, the present inventors have proposed an electrical insulating oil composition which has a suitable viscosity for use as an electrical insulating oil and which is excellent in oxidation stability and has a good outward appearance (see PTL 1).

### CITATION LIST

### Patent Literature

### PTL 1: JP-A 2007-220468

### SUMMARY OF INVENTION

### Technical Problem

From the viewpoint of maintenance management, the technique of PTL 1 is useful. However, in recent years, an electrical insulating oil composition is required to satisfy further severer conditions than existing standards. As one example, in IEC60296, an electrical insulating oil composition is classified into categories of an antioxidant-free oil, an oil with a trace of antioxidant and an antioxidant-added oil, depending on the amount of the antioxidant added to the oil. Accordingly, for example, even when the amount of the antioxidant to be added is reduced than before, it is desired that the oil composition can still keep oxidation stability for a long period of time on a level comparable to that of existing products or on a level higher than that of existing products. Consequently, further improvement of electrical insulating oil compositions has become necessary.

With that, an object of the present invention is to provide an electrical insulating oil composition excellent in both electric insulation characteristics and oxidation stability.

### Solution to Problem

The present inventors have assiduously studied and, as a result, have found that the above-mentioned problems can be solved by using a specific base oil. The present invention has been completed on the basis of the finding.

Specifically, the present invention provides an electrical insulating oil composition containing, as base oils, (A) one or more selected from hydrorefined mineral oils and synthetic hydrocarbon oils, and (B) a naphthenic solvent-refined mineral oil that has a ratio of carbon atoms in the naphthene content (% C_{N}) of 50% or more and 70% or less in ring analysis according to an n-d-M method, an acid value of 0.03 mg KOH/g or less and a sulfur content of 0.1% by mass or less, and the electrical insulating oil composition contains the component (B) in an amount of 50% by mass or more and 70% by mass or less based on the total amount of the base oils, and has a flash point of 135° C. or higher as measured according to a closed cup flash point test method, a pour point of −40° C. or lower, and a density of 0.895 g/cm³ or less.

### Advantageous Effects of Invention

According to the present invention, there can be provided an electrical insulating oil composition more excellent in both electrical insulation characteristics and oxidation stability than before.

### DESCRIPTION OF EMBODIMENTS

### [Electrical Insulating Oil Composition]

The electrical insulating oil composition of the present invention contains, as base oils, (A) one or more selected from hydrorefined mineral oils and synthetic hydrocarbon oils, and (B) a naphthenic solvent-refined mineral oil that has a ratio of carbon atoms in the naphthene content (% C_{N}) of 50% or more and 70% or less in ring analysis according to an n-d-M method, an acid value of 0.03 mg KOH/g or less and a sulfur content of 0.1% by mass or less, and the electrical insulating oil composition contains the component (B) in an amount of 50% by mass or more and 70% by mass or less based on the total amount of the base oils. The electrical insulating oil composition of the present invention has a flash point of 135° C. or higher, a pour point of −40° C. or lower, and a density of 0.895 g/cm³ or less.

### [Component (A)]

The component (A) is one or more selected from hydrorefined mineral oils and synthetic hydrocarbon oils. Not specifically defined, the crude oil for producing the hydrorefined mineral oil for use as the component (A) may be any one, including, for example, paraffinic crude oils, naphthenic crude oils, etc. The hydrorefined mineral oil includes, for example, those produced through reduced-pressure distillation of a residual oil after atmospheric distillation of the above-mentioned crude oil, followed by hydrorefining the resultant reduced-pressure distillate. In addition, also employable here are those produced by a combination with any conventionally-known refining process of dewaxing treatment, deasphalting treatment or the like, apart from the hydrorefining treatment. Here, the hydrorefining treatment indicates (1) ring opening and dealkylation of side chains of a polycyclic compound through hydrogenolysis, (2) isomerization, or (3) hydrogenation under a relatively severe condition to induce removal of a hetero atom from a hetero atom-containing hydrocarbon.

In the hydrorefined mineral oil for use as the component (A), the total aromatic content (% C_{A}) in ring analysis according to an n-d-M method is preferably 3% or more and 15% or less, more preferably 6% or more and 12% or less. The sulfur content is preferably 0.05% by mass or less, more preferably 0.02% by mass or less.

The synthetic hydrocarbon oil for use as the component (A) concretely includes hydrocarbon-based synthetic oils such as poly-α-olefins (polybutene, 1-octene oligomer, 1-decene oligomer, etc.), polybutene, alkylbenzenes, alkylnaphthalenes, alkyldiphenylalkanes (alkyldiphenylethane, alkylphenylxylylethane, benzyltoluene, etc.), alkylbiphenyls, etc.; oxygen-containing synthetic oils such as diesters (ditridecyl glutarate, di-2-ethylhexyl adipate, diisodecyl adipate, ditridecyl adipate, di-2-ethylhexyl sebacate, etc.), polyol esters (trimethylolpropane caprylate, trimethylolpropane pelargonate, pentaerythritol 2-ethylhexanoate, pentaerythritol pelargonate, etc.), polyoxyalkylene glycols, polyphenyl ethers, etc.; silicone oils, perfluoroalkyl ethers, etc.

In the present invention, one type of the above-mentioned hydrorefined mineral oils may be used, or two or more types thereof may be used as combined. Also one type of the above-mentioned synthetic oils may be used, or two or more types thereof may be used as combined. Further, one or more of the hydrorefined mineral oils and one or more of the synthetic oils may be used as combined.

The hydrorefined mineral oils and the synthetic hydrocarbon oils for use as the component (A) preferably have the properties mentioned below, from the viewpoint of controlling the density of the electrical insulating oil composition to be 0.895 g/cm³ or less.

The kinematic viscosity at 40° C. of the component (A) is preferably 5 mm²/s or more and 30 mm²/s or less. Having 5 mm²/s or more, the volatility of the component would not be too high, and the probability of providing a safety problem could be reduced. Having 30 mm²/s or less, the viscosity control of the electrical insulating oil composition could be easy, and there would hardly occur problems of hue, stability, clay treatment and others to be caused by the presence of large quantities of impurities in the composition. From these viewpoints, the kinematic viscosity at 40° C. is more preferably 6 mm²/s or more and 20 mm²/s or less, and even more preferably 7 mm²/s or more and 15 mm²/s or less.

The kinematic viscosity at 100° C. of the component (A) is preferably 0.5 mm²/s or more and 10 mm²/s or less. Falling within the range of from 0.5 mm²/s to 10 mm²/s, a preferred electrical insulating oil composition can be obtained, like in the case of the kinematic viscosity at 40° C. mentioned above. From this viewpoint, a range of from 1 mm²/s to 7 mm²/s is more preferred, and a range of from 1.5 mm²/s to 5 mm²/s is even more preferred.

The flash point of the component (A), as measured according to a closed cup flash point test method, is preferably 130° C. or higher and 280° C. or lower, more preferably 140° C. or higher and 200° C. or lower.

The pour point of the component (A) is preferably −10° C. or lower, more preferably −15° C. or lower, even more preferably −20° C. or lower, still more preferably −25° C. or lower, and most preferably −27.5° C. or lower.

The acid value of the component (A) is preferably 0.03 KOH/g or less, more preferably 0.02 mg KOH/g or less, and most preferably 0.01 mg KOH/g or less.

The sulfur content in the component (A) is preferably 0.03% by mass or less, more preferably 0.02% by mass or less, most preferably 0.01% by mass or less.

The viscosity index of the component (A) is preferably 80 or more, more preferably 90 or more, even more preferably 95 or more, still more preferably 100 or more.

The density of the component (A) is preferably 0.895 g/cm³ or less, more preferably 0.890 g/cm³ or less, even more preferably 0.875 g/cm³ or less, still more preferably 0.870 g/cm³ or less, and most preferably 0.860 g/cm³ or less.

The amount to be incorporated of the component (A) is preferably 30% by mass or more and 50% by mass or less, based on the total amount of the base oils. When the amount is 30% by mass or more based on the total amount of the base oils, the pour point may be lowered. On the other hand, when the amount is 50% by mass or less based on the total amount of the base oils, the oxidation stability can be maintained. From these viewpoints, the amount to be incorporated of the component (A) is more preferably 35% by mass or more and 45% by mass or less.

### [Component (B)]

The component (B) for use in the electrical insulating oil composition of the present invention is a naphthenic solvent-refined mineral oil to be obtained in solvent refining of a naphthenic crude oil. The naphthenic solvent-refined mineral oil includes, for example, those produced through reduced-pressure distillation of a residual oil after atmospheric distillation of a naphthenic crude oil, followed by solvent extraction of the resultant reduced-pressure distillate. In addition, also employable here are those produced by a combination with any conventionally-known refining process of dewaxing treatment, deasphalting treatment, hydrogenation finishing or the like, apart from the solvent-extraction treatment. Here, the hydrogenation finishing generally includes a hydrogenation treatment under a relatively low pressure for the purpose of hue improvement, etc., and differs from the above-mentioned hydrorefining treatment. In the present invention, a reduced-pressure distillate having a specific kinematic viscosity as mentioned below is solvent-refined to improve the oxidation stability by utilizing the sulfur compound and the like contained in the distillate fraction.

The naphthenic solvent-refined mineral oil of the component (B) has the following properties.

The naphthenic solvent-refined mineral oil has a ratio of carbon atoms in the naphthene content (% C_{N}) of 50% or more and 70% or less relative to the total carbon number of the naphthenic solvent-refined mineral oil, in ring analysis according to an n-d-M method.

When the % C_{N} is less than 50%, the absorbability of hydrogen gas into the electrical insulating oil composition would be insufficient, but when it is more than 70%, the density and the pour point of the electrical insulating oil composition could not be on a practicable level. From these viewpoints, the % C_{N} is preferably 51% or more and 67% or less, more preferably 52% or more and 65% or less.

The acid value of the naphthenic solvent-refined mineral oil is 0.03 mg KOH/g or less. When the acid value is more than 0.03 mg KOH/g, the mineral oil could hardly maintain oxidation stability for a long period of time. The acid value is preferably 0.01 mg KOH/g or less.

The sulfur content of the naphthenic solvent-refined mineral oil is preferably 0.1% by mass or less based on the total mass of the naphthenic solvent-refined mineral oil. When the sulfur content is more than 0.1% by mass, the composition could not have good electrical insulation characteristics. From this viewpoint, the sulfur content is preferably 0.08% by mass or less, more preferably 0.06% by mass or less.

The other properties of the naphthenic solvent-refined mineral oil of the component (B) are mentioned below.

The kinematic viscosity at 40° C. of the component (B) is preferably 5 mm²/s or more and 100 mm²/s or less. When the kinematic viscosity at 40° C. is 5 mm²/s or more, the volatility of the mineral oil would not be too high, and would not provide a safety problem. When the kinematic viscosity at 40° C. is 100 mm²/s or less, there would hardly occur a problem that the viscosity control of the electrical insulating oil composition would be difficult and there would also hardly occur problems of hue, stability, clay treatment amount and others to be caused by the presence of large quantities of impurities in the composition. From these viewpoints, the kinematic viscosity at 40° C. is more preferably 5 mm²/s or more and 50 mm²/s or less, and even more preferably 9 mm²/s or more and 15 mm²/s or less.

The kinematic viscosity at 100° C. of the component (B) is preferably 0.5 mm²/s or more and 10 mm²/s or less, more preferably 1 mm²/s or more and 7 mm²/s or less, and even more preferably 2 mm²/s or more and 5 mm²/s or less. Falling within the range, the volatility could be suitable and there would occur no safety problem.

The flash point of the component (B), as measured according to a closed cup flash point test method, is preferably 130° C. or higher and 280° C. or lower, more preferably 140° C. or higher and 200° C. or lower.

The pour point of the component (B) is preferably −10° C. or lower, more preferably −15° C. or lower, even more preferably −20° C. or lower, still more preferably −30° C. or lower, and most preferably −40° C. or lower.

The viscosity index of the component (B) is preferably 20 or more.

The density of the component (B) is preferably 0.920 g/cm³ or less, more preferably 0.915 g/cm³ or less, even more preferably 0.910 g/cm³ or less.

The naphthenic solvent-refined mineral oil having the above-mentioned properties contributes the excellent oxidation stability of the electrical insulating oil composition of the present invention.

In the present invention, one type of the solvent-refined mineral oil may be used, or two or more types thereof may be used as combined. The base oils in the electrical insulating oil composition of the present invention contain the hydrorefined mineral oil and/or the synthetic hydrocarbon oil, and the solvent-refined mineral oil, or that is, the base oils contain the component (A) and the component (B).

The component (B) is contained in an amount of 50% by mass or more and 70% by mass or less, based on the total amount of the base oils. When the amount is less than 50% by mass, the oxidation stability would lower, but when more than 70% by mass, the pour point would be high. From these viewpoints, the amount to be incorporated of the component (B) is more preferably 55% by mass or more and 65% by mass or less, even more preferably 57% by mass or more and 63% by mass or less.

### [Other Components]

The electrical insulating oil composition of the present invention may contain any other additive in addition to the above-mentioned components. The additive includes an antioxidant, a metal deactivator, a pour-point depressant, etc.

The antioxidant includes phenolic antioxidants, amine-based antioxidants, molybdenum-amine-based antioxidants, sulfur-containing antioxidants, etc. In the case where an antioxidant is incorporated in the composition, the amount thereof may be less than 0.08% by mass based on the total amount of the composition, or may be 0.08% by mass or more and 0.4% by mass or less based on the total amount of the composition.

In IEC60296 that is one example of standards of electrical insulating oil, electrical insulating oil is classified into categories of an antioxidant-free oil, an oil with a trace of antioxidant and an antioxidant-added oil, depending on the amount of the antioxidant added to the oil. Concretely, the amount of the antioxidant added thereto is defined to be 0% by mass based on the total amount of the composition in the “antioxidant-free oil”, the amount is to be less than 0.08% by mass based on the total amount of the composition in the “oil with a trace amount of antioxidant”, and the amount is to be 0.08% by mass or more and 0.4% by mass or less in the “antioxidant-added oil”.

In existing electrical insulating oil, when the amount of the additive such as antioxidant or the like to be incorporated is desired to meet the standards, the properties of the base oils must be changed in accordance with the amount of the additive added. With that, it is complicated to prepare an electrical insulating oil composition that meets the standards, and there are severe problems in point of loss of the production cost and the man-hours for production.

As opposed to this, even though the amount of the antioxidant to be incorporated therein is changed in accordance with the above-mentioned standard value, the electrical insulating oil composition of the present invention can still satisfy the desired electrical insulation characteristics and oxidation stability, not requiring the necessity of specifically controlling the properties of the base oils (the base oil fractions containing the component (A) and the component (B) in the present invention).

Specifically, according to the electrical insulating oil composition of the present invention, the base oil fractions therein can be commonalized, and there can be provided an electrical insulating oil composition capable of satisfying the electrical insulation characteristics and oxidation stability that meet the standards merely by controlling the amount of the antioxidant to be incorporated therein in accordance with the standards, and consequently, the present invention is advantageous in that loss of the production cost and the man-hours for production can be reduced.

### [Properties of Electrical Insulating Oil Composition]

The electrical insulating oil composition of the present invention has the following properties.

The flash point of the electrical insulating oil composition of the present invention, as measured according to a closed cup flash point test method (PM), is 135° C. or higher, preferably 140° C. or higher, more preferably 145° C. or higher.

When the flash point of the electrical insulating oil composition, as measured according to a closed cup flash point test method (PM), is lower than 135° C., the oil composition could not satisfy the safety standard on a practicable level.

The flash point of the electrical insulating oil composition of the present invention, as measured according to an open cup flash point test method (COC), is 140° C. or higher, preferably 145° C. or higher, more preferably 150° C. or higher.

The pour point of the electrical insulating oil composition of the present invention is −40° C. or lower, preferably −41° C. or lower, more preferably −42° C. or lower. When the pour point is higher than −40° C., then the oil composition could not satisfy the performance under low-temperature conditions.

The density of the electrical insulating oil composition of the present invention must be 0.895 g/cm³ or less. When the density is more than 0.895 g/cm³, ice that may be formed of the water in the electrical insulating oil composition in cold climates and the like could not be settled and therefore the ice would float in the electrical insulating oil composition and, as a result, the ice would act as a conductor to cause short-circuiting. From the above viewpoints, the density of the electrical insulating oil composition is more preferably 0.890 g/cm³ or less, even more preferably 0.885 g/cm³ or less, and still more preferably 0.880 g/cm³ or less.

The other properties of the electrical insulating oil composition of the present invention are as follows.

The kinematic viscosity at 40° C. of the electrical insulating oil composition of the present invention is preferably 5 mm²/s or more and 15 mm²/s or less, more preferably 6 mm²/s or more and 14 mm²/s or less, even more preferably 7 mm²/s or more and 12 mm²/s or less. Having 5 mm²/s or more, the volatility of the oil composition would be hardly too high and the flash point thereof would not lower, and the probability of providing a safety problem could be reduced. Having 15 mm²/s or less, the flowability of the oil composition would not lower to evade the difficulty in oil circulation in apparatus, and therefore the probability of providing any influence on cooling performance could be reduced.

The kinematic viscosity at 100° C. of the oil composition is preferably 1 mm²/s or more and 10 mm²/s or less. When the kinematic viscosity at 100° C. falls within the range, the volatility of the oil composition could be suitable and there would not cause any safety problem. From these viewpoints, more preferred is a range of 1.5 mm²/s or more and 9 mm²/s or less, and even more preferred is a range of 2 mm²/s or more and 8 mm²/s or less.

The acid value of the oil composition is preferably 0.02 mg KOH/g or less, more preferably 0.01 mg KOH/g or less.

The value of dielectric tangent at 90° C. of the electric insulating oil composition of the present invention is preferably 0.01% or less. When the dielectric tangent at 90° C. thereof is 0.01% or less, the oil composition can have good electrical insulation characteristics. From this viewpoint, the value of dielectric tangent is more preferably 0.009% or less, even more preferably 0.008% or less.

The electrical insulating oil composition having the above-mentioned properties can satisfy the requirements of sludge generation of 0.8% or less after insulating oil oxidation test, acid value of 1.2 mg KOH/g or less and dielectric tangent at 90° C. of 50% or less, in the evaluation test based on the IEC61125 Standard C Method.

### [Use]

The electrical insulating oil composition of the present invention can be used as insulating oil for use in oil-filled capacitor, oil-filled cables, oil-filled transformers, oil circuit breakers, etc. Above all, the electrical insulating oil composition having the above-mentioned properties satisfies the quality standards of insulating oil in IEC60296 for use for transformers.

### Examples

The present invention is described in more detail by Examples hereinunder. The present invention is not limited to the following Examples.

The base oils used in Examples and Comparative Examples are shown below, and the properties thereof are shown in Table 1.

Oil A: naphthenic solvent-refined mineral oil

Oil B: hydrorefined paraffin oil

Oil C: hydrorefined paraffin oil

Oil D: naphthenic hydrorefined mineral oil

Oil E: paraffinic solvent-refined mineral oil

Oil F: naphthenic solvent-refined mineral oil

TABLE 1

| | | Oil A | Oil B | Oil C | Oil D | Oil E | Oil F |
|---|---|---|---|---|---|---|---|
| Kinematic Viscosity | 40° C. | 9.106 | 7.667 | 12.73 | 9.183 | 9.320 | 9.089 |
| (mm²/s) | 100° C. | 2.247 | 2.270 | 3.106 | 2.255 | 2.534 | 2.245 |
| Viscosity Index | | 27 | 106 | 103 | 25 | 97 | 27 |
| Density (g/cm³) | | 0.9069 | 0.8254 | 0.8367 | 0.9083 | 0.8454 | 0.9066 |
| Flash Point COC(° C.) | | 155 | 154 | 194 | 150 | 176 | 156 |
| Flash Point PM (° C.) | | 148 | 146 | 182 | 144 | 168 | 147 |
| Pour Point (° C.) | | −50.0> | −32.5 | −35.0 | −50.0> | −12.5 | −50.0> |
| Acid Value (mg KOH/g) | | 0.01 | 0.01> | 0.01> | 0.01> | 0.01 | 0.05 |
| Sulfur Content (mass %) | | 0.05 | 0.01> | 0.01> | 0.02 | 0.16 | 0.05 |
| Ring analysis n-d-M | % C_{A} | 9.8 | 0.2 | 0.0 | 10.6 | 4.7 | 9.8 |
| | % C_{N} | 55.3 | 24.5 | 27.5 | 54.9 | 28.7 | 55.4 |
| | % C_{P} | 34.9 | 75.3 | 72.5 | 34.6 | 66.6 | 34.8 |

The properties shown in Table 1 were determined according to the measurement methods mentioned below.

Kinematic viscosity (40° C., 100° C.) and viscosity index: measured according to JIS K 2283.
Density: measured according to JIS K 2249.
Flash point (open cup flash point test method): measured according to JIS K 2265 (Cleveland open cup, COC).
Flash point (closed cup flash point test method): measured according to JIS K 2265-6 (Pensky-Martens closed cup flash point test method, PM).
Pour point: measured according to JIS K 2269.
Acid value: measured according to JIS K 2501.
Sulfur content: measured according to JIS K 2541.
Ring analysis: measured according to ASTM D-3238, ring analysis (n-d-M method.

### [Evaluation Test]

Using the above-mentioned oils A to F, electrical insulating oil compositions of Examples 1 to 6 and Comparative Examples 1 to 5 were prepared according to the formulations shown in Table 2. The prepared electrical insulating oil compositions were evaluated according to the evaluation test method based on the IEC61125 Standard C Method, and those having, as a fresh sample thereof, a density of 0.895 g/cm³ or less, a pour point of −40° C. or lower, an acid value of 0.01 mg KOH/g or less and a dielectric tangent (90° C.) of 0.5% or less were considered to be appropriate. In addition, those having, after insulating oil oxidation test, a sludge amount of 0.8% or less, an acid value of 1.2 mg KOH/g or less and a dielectric tangent (90° C.) of 50% or less were considered to be appropriate. The evaluation results are shown in Table 2.

TABLE 2

| | | Example 1 | Example 2 | Example 3 | Example 4 | Example 5 | Example 6 |
|---|---|---|---|---|---|---|---|
| Blend Ratio (mass %) | Oil A | 60 | 60 | 60 | 60 | 60 | 60 |
| | Oil B | 40 | — | 40 | 40 | — | — |
| | Oil C | — | 40 | — | — | 40 | 40 |
| | Oil D | — | — | — | — | — | — |
| | Oil E | — | — | — | — | — | — |
| | Oil F | — | — | — | — | — | — |

| | | | | | | |
|---|---|---|---|---|---|---|
| Antioxidant (mass %) | 0 | 0 | 0.3 | 0.07 | 0.3 | 0.07 |
| Clay Treatment (mass %) | 1 | 1 | 1 | 1 | 1 | 1 |
| Kinematic Viscosity (40° C.) | 8.192 | 10.35 | 8.192 | 8.192 | 10.35 | 10.35 |
| (mm²/s) | | | | | | |
| Kinematic Viscosity (100° C.) | 2.230 | 2.567 | 2.230 | 2.23 | 2.567 | 2.567 |
| (mm²/s) | | | | | | |
| Density of Fresh Oil (g/cm³) | 0.8725 | 0.8776 | 0.8725 | 0.8725 | 0.8776 | 0.8776 |
| Flash Point of Fresh Oil COC(° C.) | 154 | 173 | 155 | 155 | 173 | 173 |
| Flash Point of Fresh Oil PM(° C.) | 146 | 165 | 146 | 146 | 165 | 165 |
| Pour Point of Fresh Oil (° C.) | −42.5 | −50.0 | −42.5 | −42.5 | −50.0 | −50.0 |
| Hue of Fresh Oil (Saybolt) | +15 | +15 | +15 | +15 | +15 | +15 |
| Hue of Fresh Oil (ASTM) | L0.5 | L0.5 | L0.5 | L0.5 | L0.5 | L0.5 |
| Acid Value of Fresh Oil (mg | 0.01 | 0.01 | 0.01 | 0.01 | 0.01 | 0.01 |
| KOH/g) | | | | | | |
| Dielectric Tangent of Fresh Oil | 0.005 | 0.003 | 0.007 | 0.006 | 0.005 | 0.004 |
| (%) 90° C. | | | | | | |
| Volume Resistivity of Fresh Oil | 110 | 37 | 85 | 100 | 12 | 20 |
| (TΩm) 80° C. | | | | | | |
| Test Time of Insulating Oil | 164 | 164 | 500 | 300 | 500 | 300 |
| Oxidation Test (hr) | | | | | | |
| Sludge Amount after Insulating | 0.50 | 0.48 | 0.68 | 0.54 | 0.67 | 0.51 |
| Oil Oxidation Test (%) | | | | | | |
| Acid Value after Insulating Oil | 0.26 | 0.30 | 0.35 | 0.28 | 0.38 | 0.29 |
| Oxidation Test (mg KOH/g) | | | | | | |
| Dielectric Tangent after | 15.1 | 12.5 | 12.5 | 14.5 | 12.1 | 13.3 |
| Insulating Oil Oxidation Test (%) | | | | | | |
| 90° C. | | | | | | |

| | | Comparative | Comparative | Comparative | Comparative | Comparative |
|---|---|---|---|---|---|---|
| | | Example 1 | Example 2 | Example 3 | Example 4 | Example 5 |
| Blend Ratio (mass %) | Oil A | 80 | 40 | 60 | 60 | — |
| | Oil B | 20 | 60 | — | — | 40 |
| | Oil C | — | — | — | — | — |
| | Oil D | — | — | 40 | — | — |
| | Oil E | — | — | — | 40 | — |
| | Oil F | — | — | — | — | 60 |

| | | | | | |
|---|---|---|---|---|---|
| Antioxidant (mass %) | 0 | 0 | 0 | 0 | 0 |
| Clay Treatment (mass %) | 1 | 1 | 1 | 1 | 1 |
| Kinematic Viscosity (40° C.) | 8.521 | 7.842 | 9.159 | 9.191 | 8.178 |
| (mm²/s) | | | | | |
| Kinematic Viscosity (100° C.) | 2.226 | 2.224 | 2.251 | 2.356 | 2.220 |
| (mm²/s) | | | | | |
| Density of Fresh Oil (g/cm³) | 0.8889 | 0.8543 | 0.9077 | 0.8823 | 0.8723 |
| Flash Point of Fresh Oil COC(° C.) | 155 | 154 | 153 | 162 | 155 |
| Flash Point of Fresh Oil PM(° C.) | 147 | 146 | 145 | 155 | 147 |
| Pour Point of Fresh Oil (° C.) | −50.0> | −40.0 | −50.0> | −25.0 | −42.5 |
| Hue of Fresh Oil (Saybolt) | +11 | +18 | +10 | +5 | −6 |
| Hue of Fresh Oil (ASTM) | L0.5 | L0.5 | L0.5 | L0.5 | L0.5 |
| Acid Value of Fresh Oil (mg | 0.01 | 0.01> | 0.01 | 0.01 | 0.03 |
| KOH/g) | | | | | |
| Dielectric Tangent of Fresh Oil | 0.786 | 0.003 | 0.085 | 0.489 | 0.921 |
| (%) 90° C. | | | | | |
| Volume Resistivity of Fresh Oil | 1> | 150 | 8 | 1> | 1> |
| (TΩm) 80° C. | | | | | |
| Test Time of Insulating Oil | — | 164 | — | — | — |
| Oxidation Test (hr) | | | | | |
| Sludge Amount after Insulating | — | 0.18 | — | — | — |
| Oil Oxidation Test (%) | | | | | |
| Acid Value after Insulating Oil | — | 1.83 | — | — | — |
| Oxidation Test (mg KOH/g) | | | | | |
| Dielectric Tangent after | — | 20.1 | — | — | — |
| Insulating Oil Oxidation Test (%) | | | | | |
| 90° C. | | | | | |

The properties shown in Table 2 were determined according to the measurement methods mentioned below.

Kinematic viscosity (40° C., 100° C.): measured according to JIS K 2283.
Density: measured according to JIS K 2249.
Flash point (open cup flash point test method): measured according to JIS K 2265 (Cleveland open cup, COC).
Flash point (closed cup flash point test method): measured according to JIS K 2265-6 (Pensky-Martens closed cup flash point test method, PM).
Pour point: measured according to JIS K 2269.
Hue: measured according to JIS K 2580 (Saybolt) and ASTM D-1500 (ASTM).
Acid value: measured according to JIS K 2501.
Dielectric tangent: measured according to IEC60247.
Volume resistivity: measured according to IEC60247.
Oxidation stability test: evaluation test based on the IEC61125 Standard Method C.

### [Evaluation Results]

As shown in Table 2, it is known that, among the electrical insulating oil compositions prepared using the above-mentioned oils A to F and according to the formulations in Table 2, the values of the electrical insulating oil compositions containing any of the oil B or the oil C as the component (A) and containing the oil A as the component (B), as evaluated according to the evaluation test methods based on the IEC61125 Standard Method C, meet the quality standards of IEC60296 insulating oil for use in transformers.

On the other hand, in Comparative Example 1, the amount of the oil A as the component (B) is more than the suitable blend ratio based on the total amount of the base oils, and therefore, the dielectric tangent (%) at 90° C. of the fresh oil is too high and the electric insulation characteristics of the oil composition are not good. In Comparative Example 2, on the other hand, the amount of the component (B) is lower than the suitable blend ratio, and therefore, the dielectric tangent (%) at 90° C. of the fresh oil meets the requirement; however, the dielectric tangent (%) at 90° C. after the insulating oil oxidation test is too high and the electric insulation characteristics of the oil composition are not good.

In Comparative Example 3, the component (A) was omitted, and therefore in this, though the electric insulation characteristics according to the evaluation were good, the density of the oil composition is more than 0.895 g/cm³. When the density of the composition is more than 0.895 g/cm³, ice that may be formed of the water in the electrical insulating oil composition in cold climates could not be settled in the electrical insulating oil composition. In such a case, the ice would float in the oil and, as a result, the ice would act as a conductor to cause short-circuiting.

In Comparative Example 4, the pour point of the fresh oil is −25° C. and is high, and in this, therefore, the oil composition could not secure flow stability at a low temperature and could not exhibit the function as an electrical insulating oil composition. In Comparative Example 5, the component (B) is not contained, and in this, therefore, the dielectric tangent (%) at 90° C. of the fresh oil is large and the electrical insulation characteristics of the oil composition are not good.

1: An electrical insulating oil composition, comprising,
as base oils,
(A) at least one of a hydrorefined mineral oil and a synthetic hydrocarbon oil; and
(B) a naphthenic solvent-refined mineral oil that has a ratio of carbon atoms in the naphthene content (% C_{N}) of 50% or more and 70% or less in ring analysis according to an n-d-M method, an acid value of 0.03 mg KOH/g or less, and a sulfur content of 0.1% by mass or less,
wherein:
the electrical insulating oil composition comprises the component (B) in an amount of 50% by mass or more and 70% by mass or less based on the total amount of the base oils; and
the electrical insulating oil has a flash point of 135° C. or higher as measured according to a closed cup flash point test method, a pour point of −40° C. or lower, and a density of 0.895 g/cm³ or less.

2: The electrical insulating oil composition according to claim 1, further comprising an antioxidant.

3: The electrical insulating oil composition according to claim 1, wherein the sulfur content in the component (B) is 0.08% by mass or less.

4: The electrical insulating oil composition according to claim 1, wherein the value of a dielectric tangent at 90° C. of the electrical insulating oil composition is 0.01% or less.

5: The electrical insulating oil composition according to claim 1, wherein the value of a dielectric tangent at 90° C. of the oil composition after the evaluation test based on the IEC61125 Standard Method C is 50% or less.

6: The electrical insulating oil composition according to claim 1, which is adapted to function in a transformer.
